(19) United States
(12) Patent Application Publication
(10) Pub. No.: US 2025/0238851 A1
(43) Pub. Date: Jul. 24, 2025

(54) PERSONALIZING RECIPES USING A LARGE LANGUAGE MODEL

(71) Applicant: Maplebear Inc., San Francisco, CA (US)

(72) Inventors: Luis Manrique, New York, NY (US); Johan Sjostrand, Oakland, CA (US)

(21) Appl. No.: 18/421,803

(22) Filed: Jan. 24, 2024

(51) Int. Cl. G06F 40/40; G06F 3/0482; G06F 3/0484; G06Q 30/0601

(52) U.S. Cl. CPC G06F 40/40; G06F 3/0482; G06F 3/0484; G06Q 30/0633

(57) ABSTRACT

An online system receives a request from a client device associated with a user to generate a recipe. Based on the request and data for the user, the system generates a prompt to generate the recipe, provides the prompt to a large language model, extracts the recipe from an output of the model, and displays an interface describing the recipe. Upon receiving an additional request to modify the recipe, a process including generating another prompt to modify the recipe, providing this prompt to the model, extracting a modified recipe from another output of the model, and updating the interface to describe the modified recipe, is performed and repeated for each additional request. When a recipe is accepted, the system predicts an availability of each associated item and updates the interface to include an option to add a set of the items to a shopping list based on the predicted availability.

### BACKGROUND

Online systems, such as online concierge systems, may receive requests from their users for various types of recipes (e.g., for making particular dishes, desserts, drinks, etc.) and the online systems may provide the recipes to the users in response to the requests. For example, suppose that an online system receives a request from a client device associated with a user of the online system for vegetarian lasagna. In this example, the online system may retrieve multiple recipes based on the request (e.g., the five top-rated vegetarian lasagna recipes, the 10 most popular vegetarian lasagna recipes, etc.) and send the recipes for display to the client device.

However, online system users may want to personalize the recipes provided by online systems for various reasons (e.g., cost, personal preferences, dietary preferences or restrictions, limited preparation time, lack of equipment, etc.), but may find it difficult to do so. In the above example, suppose that the user is on a gluten-free, plant-based diet and wants to modify one or more of the recipes based on their dietary restrictions while staying within a budget. In this example, the user may find it difficult to modify the recipe(s) if they are not familiar with gluten-free, plant-based alternatives to some of the ingredients (e.g., cheese, lasagna noodles, etc.). Furthermore, in the above example, even if the user is able to find alternatives to the ingredients, the user would then have to check whether each of the alternative ingredients is available and identify a combination of the alternative ingredients that stays within their budget, which may be a complicated, time-consuming, and frustrating process.

### SUMMARY

In accordance with one or more aspects of the disclosure, an online system personalizes recipes for online system users using a large language model. More specifically, an online system receives a request from a client device associated with a user of the online system to generate a set of recipes and retrieves a set of user data associated with the user. Based on the request and the set of user data, the online system generates a first prompt to generate the set of recipes, provides the prompt to a large language model to obtain a first textual output, and extracts the set of recipes from the output. The online system displays a user interface including a set of information describing each recipe and a set of options to modify or accept the recipe. Responsive to receiving an additional request from the client device to modify a recipe, the online system performs a recipe modification process that includes generating a second prompt to modify the recipe based on the additional request, the set of information describing the recipe, and the set of user data. The recipe modification process also includes providing the second prompt to the large language model to obtain a second textual output, extracting a set of modified recipes from the output, and updating the user interface to include the set of information describing each modified recipe and the set of options to modify or accept the modified recipe. The online system repeats the recipe modification process for each additional request received from the client device to modify a recipe until a modified recipe is accepted. Responsive to receiving a selection of an accepted recipe from the client device, the online system predicts an availability of each item associated with the accepted recipe at a retailer location and updates the user interface to include an additional option to add a set of items associated with the accepted recipe to a shopping list associated with the user based on the predicted availability of each item.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for personalizing a recipe for an online system user using a large language model, in accordance with one or more embodiments.

FIGS. 4A-4G illustrate examples of a user interface for personalizing a recipe for an online system user using a large language model, in accordance with one or more embodiments.

### DETAILED DESCRIPTION

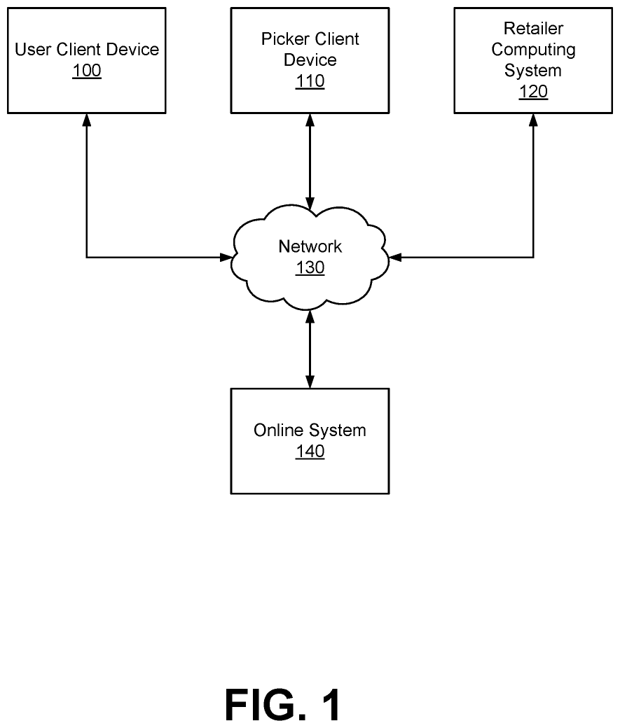

FIG. 1 illustrates an example system environment for an online system 140, such as an online concierge system, in accordance with one or more embodiments. The system environment illustrated in FIG. 1 includes a user client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online system 140. As such, there may be more than one user client device 100, picker client device 110, or retailer computing system 120.

The user client device 100 is a client device through which a user may interact with the picker client device 110, the retailer computing system 120, or the online system 140. The user client device 100 can be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer location. The picker client device 110 presents the items that are included in the user's order to the picker in a collection interface. The collection interface is a user interface that provides information to the picker identifying items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140. Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a user from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a particular retailer location and the quantities of those items. Additionally, the retailer computing system 120 may transmit updated item data to the online system 140 when an item is no longer available at the retailer location. Furthermore, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The user client device 100, the picker client device 110, the retailer computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

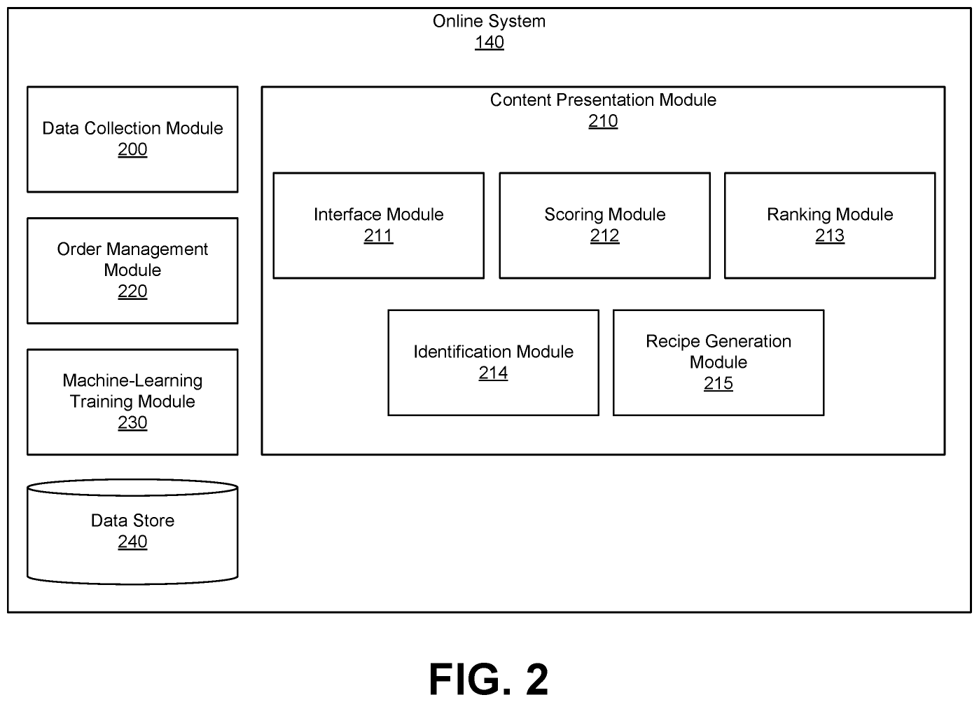

The online system 140 may be an online concierge system by which users can order items to be provided to them by a picker from a retailer. The online system 140 receives orders from a user client device 100 through the network 130. The online system 140 selects a picker to service the user's order and transmits the order to a picker client device 110 associated with the picker. The picker collects the ordered items from a retailer location and delivers the ordered items to the user. The online system 140 may charge a user for the order and provide portions of the payment from the user to the picker and the retailer. As an example, the online system 140 may allow a user to order groceries from a grocery store retailer. The user's order may specify which groceries they want delivered from the grocery store and the quantities of each of the groceries. The user's client device 100 transmits the user's order to the online system 140 and the online system 140 selects a picker to travel to the grocery store retailer location to collect the groceries ordered by the user. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, such as an online concierge system, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

The data collection module 200 collects user data, which is information or data describing characteristics of a user. User data may include a user's name, address, stored payment instruments, or preferences/restrictions (e.g., shopping preferences, dietary restrictions, favorite items, etc.). For example, user data may include a user's dietary preferences (e.g., spicy foods) or restrictions (e.g., vegetarian and lactose-free) and for items having certain attributes (e.g., organic and environmentally-friendly). As an additional example, user data may include a user's shopping preferences, such as the user's preferred or favorite items or retailers or the user's preference to purchase certain types of items in bulk or from certain retailers. User data also may include demographic information associated with a user (e.g., age, gender, geographical region, etc.) or household information associated with the user (e.g., a number of people included in the user's household, whether the user's household includes children or pets, the user's household income, etc.). The user data also may include default settings established by the user, such as a default retailer/retailer location, payment instrument, delivery location, or delivery timeframe.

User data also may include information describing a user's interactions with the online system 140. Examples of such types of information include: requests received from a user client device 100 associated with the user (e.g., to generate or modify recipes), items added to a shopping list associated with the user, orders placed by the user, recipes the user accepted, shared, or saved, etc. User data may include historical information (e.g., historical order or interaction information) associated with a user. For example, user data may describe previous orders placed by a user with the online system 140 or previous purchases made by the user at retailer locations. As an additional example, user data may describe previous interactions by a user with recipes, items, or other types of content (e.g., coupons, advertisements, etc.) presented by the online system 140 and may describe the recipes (e.g., cuisines, ingredients, etc. associated with the recipes), the items (e.g., types, prices, etc. associated with the items), or the other types of content (e.g., discounts, items, etc. associated with coupons, advertisements, etc.). In this example, the user data may also describe the types of interactions (e.g., accepting, modifying, viewing, sharing, or saving a recipe, browsing or searching for an item, clicking on an advertisement, etc.) and the times of the interactions (e.g., a timestamp associated with each interaction).

User data also may include information that is derived from other types of information, such as information that is derived from other user data. For example, based on historical order or purchase information associated with a user, user data may include a frequency with which the user orders or purchases items of a particular type or brand, a percentage of items the user orders/purchases that are on sale, an average amount a user spends on each order, etc. As an additional example, based on historical interaction information associated with a user, user data may include a frequency with which the user accepts recipes including particular ingredients, requiring particular types of equipment, using particular techniques, etc. The data collection module 200 may collect the user data from sensors on the user client device 100 or based on the user's interactions with the online system 140.

The data collection module 200 also collects item data, which is information or data identifying and describing items that are available at a retailer location. The item data may include item identifiers for items that are available and may include quantities of items associated with each item identifier. Additionally, item data may also include attributes of items such as the sizes, colors, weights, stock keeping units (SKUs), serial numbers, prices, item categories, brands, qualities (e.g., freshness, ripeness, etc.), ingredients, materials, manufacturing locations, versions/varieties (e.g., flavors, low fat, gluten-free, organic, etc.), or any other suitable attributes of the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as butter, margarine, avocado oil, olive oil, coconut oil, vegetable oil, ghee, lard, canola oil, etc. may be included in an “oils/fats” item category. Furthermore, in various embodiments, an item may be included in multiple categories. For example, organic strawberries may be included in an “organic strawberries” item category, a “strawberries” item category, and an “organic fruit” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the retailers from which the picker has collected items, or the picker's previous shopping history. Additionally, the picker data may include preferences expressed by the picker, such as their preferred retailers for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The data collection module 200 also may collect recipe data, which is information or data describing characteristics of a recipe. Recipe data for a recipe may include information identifying the recipe (e.g., a name or a title of the recipe), a cuisine (e.g., American, Thai, Italian, etc.) associated with the recipe, a meal (e.g., brunch, dessert, etc.) associated with the recipe, a short description of the recipe, a complexity of the recipe (e.g., easy, intermediate, or difficult), or a set of ingredients included in the recipe. Recipe data for a recipe also may include an amount or a quantity of each ingredient used to make the recipe, a set of equipment used to make the recipe (e.g., a rolling pin, a food processor, etc.), a set of instructions for making the recipe, an amount of time required to make the recipe, a set of nutritional information associated with the recipe, or a number of servings the recipe yields. Recipe data for a recipe further may include a rating for the recipe, information describing a measure of popularity of the recipe (e.g., a number of users who have indicated they have made the recipe, a number of times the recipe was saved or shared, etc.), one or more images or videos associated with the recipe, or any other suitable types of information that may be associated with a recipe.

Additionally, in some embodiments, recipe data includes a recipe graph maintained by the data collection module 200 identifying connections between recipes. A connection between a recipe and another recipe indicates that the connected recipes each have one or more common attributes (e.g., common ingredients, common instructions, etc.). In some embodiments, a connection between a recipe and another recipe indicates that a user included items from each connected recipe in a common order or included items from each connected recipe in orders the online system 140 received from the user within a threshold amount of time of each other. In various embodiments, a connection between a recipe and another recipe indicates that the connected recipes are variants of each other. For example, if two recipes are connected, one recipe may be a vegetarian version of the other recipe. As an additional example, two connected recipes may include the same ingredients but use different techniques (e.g., air frying rather than deep frying) or different types of equipment (e.g., a slow cooker rather than an oven). In some embodiments, each connection between recipes includes a value, with the value providing an indication of a strength of a connection between the recipes. For example, a value included in a connection between two recipes may indicate a measure of similarity between the recipes. The data collection module 200 may collect recipe data from a user of the online system 140, the recipe generation module 215 (described below), a third-party system (e.g., a website or an application), or any other suitable source.

The content presentation module 210 selects content for presentation to a user. For example, the content presentation module 210 selects which items to present to a user while the user is placing an order. Components of the content presentation module 210 include: an interface module 211, a scoring module 212, a ranking module 213, an identification module 214, and a recipe generation module 215, which are further described below.

The interface module 211 generates a user interface with which users of the online system 140 may interact and sends the user interface for display to user client devices 100 associated with the users. In some embodiments, in generating the user interface, the interface module 211 generates an ordering interface for a user to order items. In such embodiments, the interface module 211 populates the ordering interface with items that the user may select for adding to their order. In some embodiments, the interface module 211 presents a catalog of all items that are available to the user, which the user can browse to select items to order. Other components of the content presentation module 210 may identify items that the user is most likely to order and the interface module 211 may then present those items to the user. For example, the scoring module 212 may score items and the ranking module 213 may rank the items based on their scores. In this example, the identification module 214 may identify items with scores that exceed some threshold (e.g., the top n items or the p percentile of items) and the interface module 211 then displays the identified items.

The interface module 211 may receive requests from users via one or more interactive elements (e.g., a text field, one or more buttons or check boxes, etc.) included in the user interface. For example, the interface module 211 may receive a request from a user client device 100 associated with a user to generate a recipe for chocolate chip cookies in a free-text format (e.g., “I want a recipe for chocolate chip cookies”) entered into a text field included in the user interface. Continuing with this example, the interface module 211 subsequently may display, via the user interface, a set of information associated with each of one or more recipes generated based on the request and a set of options associated with each recipe (e.g., to view, accept, modify, share, or save the recipe), as further described below. In this example, the interface module 211 may then receive an additional request from the user client device 100 to modify a recipe or a selection of an accepted recipe when the user interacts with a corresponding interactive element, as also further described below.

The scoring module 212 may use an item selection model to score items for presentation to a user. An item selection model is a machine-learning model that is trained to score items for a user based on item data for the items and user data for the user. For example, the item selection model may be trained to determine a likelihood that the user will order an item. In some embodiments, the item selection model uses item embeddings describing items and user embeddings describing users to score items. These item embeddings and user embeddings may be generated by separate machine-learning models and may be stored in the data store 240.

In some embodiments, the scoring module 212 scores items based on a search query received from the user client device 100. A search query is free text for a word or set of words that indicate items of interest to the user. The scoring module 212 scores items based on a relatedness of the items to the search query. For example, the scoring module 212 may apply natural language processing (NLP) techniques to the text in the search query to generate a search query representation (e.g., an embedding) that represents characteristics of the search query. The scoring module 212 may use the search query representation to score candidate items for presentation to a user (e.g., by comparing a search query embedding to an item embedding).

In some embodiments, the scoring module 212 scores items based on a predicted availability of an item. The scoring module 212 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The scoring module 212 may apply a weight to the score for an item based on the predicted availability of the item. Alternatively, an item may be filtered out from presentation to a user by the identification module 214 based on whether the predicted availability of the item exceeds a threshold.

The scoring module 212 also may score recipes for presentation to a user. The scoring module 212 may score a recipe by predicting a likelihood that the user will accept the recipe and scoring the recipe based on the predicted likelihood (e.g., such that the score is proportional to the predicted likelihood). Once the scoring module 212 scores the recipes, other components of the content presentation module 210 may identify a set of the recipes for presentation to the user. For example, the ranking module 213 may rank the recipes based on their scores, the identification module 214 may identify recipes with scores that exceed some threshold (e.g., the top n recipes or the p percentile of recipes), and the interface module 211 then displays a set of information describing each of the identified recipes.

The scoring module 212 may predict a likelihood that a user will accept a recipe based on a set of user data associated with the user, a set of recipe data associated with the recipe, or any other suitable types of information. For example, suppose that a set of user data associated with a user includes information describing recipes previously accepted by the user (e.g., a cuisine or a meal associated with each recipe, a complexity of each recipe, a set of ingredients included in each recipe, a set of nutritional information associated with each recipe, etc.). In this example, the scoring module 212 may predict a likelihood that the user will accept a recipe based on a measure of similarity between the recipe and other recipes previously accepted by the user, such that the likelihood is proportional to the measure of similarity. In the above example, the scoring module 212 also may predict the likelihood based on additional types of user data associated with the user (e.g., a set of preferences or restrictions associated with the user, household or demographic information associated with the user, historical order information associated with the user, etc.). In this example, once the recipe generation module 215 identifies one or more items corresponding to each ingredient included in the recipe (as described below), the scoring module 212 may predict the likelihood, such that it is proportional to a number or a percentage of the ingredients corresponding to items the user previously ordered, the user's favorite or preferred items, etc. Similarly, in the above example, the likelihood may be inversely proportional to a number/percentage of ingredients corresponding to items the user does not like or prefer (e.g., based on a dietary restriction associated with the user). In the above example, the scoring module 212 also may predict the likelihood based on recipe data associated with other recipes having at least a threshold measure of similarity to the recipe (e.g., other recipes to which it is connected in the recipe graph), such that the likelihood may be proportional to an average measure of popularity of these recipes or an average rating for these recipes.

In some embodiments, the scoring module 212 predicts a likelihood that a user will accept a recipe using a recipe acceptance prediction model. A recipe acceptance prediction model is a machine-learning model trained to predict a likelihood that a user will accept a recipe. To use the recipe acceptance prediction model, the scoring module 212 may access the model (e.g., from the data store 240) and apply the model to a set of inputs. The set of inputs may include various types of information described above, such as a set of user data associated with a user, a set of recipe data associated with a recipe, or any other suitable types of information. For example, the set of inputs may include historical interaction information associated with a user describing recipes the user previously accepted, historical order information describing items the user previously ordered, a set of preferences or restrictions associated with the user, demographic and household information associated with the user, etc. Continuing with this example, the set of inputs further may include recipe data associated with a recipe, such as a cuisine or a meal associated with the recipe, a complexity of the recipe, a set of ingredients included in the recipe, a set of nutritional information associated with the recipe, etc. Once the scoring module 212 applies the recipe acceptance prediction model to a set of inputs, the scoring module 212 may then receive an output from the model corresponding to a likelihood that a user will accept a recipe. Continuing with the above example, the output received by the scoring module 212 may correspond to a value (e.g., a percentage) indicating a predicted likelihood that the user will accept the recipe. In some embodiments, the recipe acceptance prediction model may be trained by the machine-learning training module 230, as further described below.

The recipe generation module 215 may retrieve a set of user data associated with a user from the data store 240. The recipe generation module 215 may do so if the interface module 211 receives a request from a user client device 100 associated with the user to generate a set of recipes. For example, upon receiving a request from a user client device 100 associated with a user to generate a recipe at the interface module 211, the recipe generation module 215 may retrieve information describing a set of dietary restrictions associated with the user (e.g., a nut allergy and a gluten sensitivity) and a set of preferences associated with the user (e.g., favorite items or cuisines). In the above example, the recipe generation module 215 also may retrieve historical order information associated with the user describing items and quantities of items the user previously ordered and historical interaction information associated with the user describing recipes the user previously accepted. In this example, the recipe generation module 215 also may retrieve information describing the user's household (e.g., four people including two children under the age of three), demographic information associated with the user (e.g., an age and a gender of the user), and an average amount a user spends on each order (e.g., between $100 and $150).

The recipe generation module 215 may generate a prompt to a large language model (LLM) to generate a set of recipes. The LLM is a trained deep-learning model (e.g., GPT-4) that generates a textual output based on the prompt. In some embodiments, the LLM is trained by the machine-learning training module 230, which is described below. A prompt may include a set of constraints associated with a set of recipes, such as a budget associated with each recipe, one or more dietary preferences or restrictions (e.g., spicy, vegetarian, etc.) associated with each recipe, a number of servings each recipe yields, or nutritional information associated with each recipe (e.g., low sodium). A set of constraints associated with a set of recipes also may include one or more ingredients or types of equipment each recipe should include or exclude, one or more attributes of an ingredient or a type of equipment (e.g., a version/variety, a quantity, a quality, a size, etc.) each recipe should include or exclude, or any other suitable types of constraints.

The recipe generation module 215 may generate a prompt to generate a set of recipes based on a request received from a user client device 100 associated with a user of the online system 140 to generate the set of recipes, a set of user data associated with the user, or any other suitable types of information. For example, suppose that the interface module 211 receives a request from a user client device 100 associated with a user of the online system 140 to generate a recipe for chocolate chip cookies. In this example, based on the request and a set of user data associated with the user indicating that one of the user's favorite items is chewy chocolate chip cookies and that the user's household includes five people, the recipe generation module 215 may generate a prompt to the LLM to generate a set of recipes that states: “Generate some recipes for chewy chocolate chip cookies that serve five people.” In some embodiments, a prompt to generate a set of recipes also includes a request for a set of suggested modifications to the set of recipes. In the above example, the prompt also may state: “Provide some popular modifications to each recipe.”

Once the recipe generation module 215 generates a prompt to the LLM, the recipe generation module 215 provides the prompt to the LLM, which generates a textual output based on the prompt. The recipe generation module 215 subsequently may receive the textual output from the LLM, in which the textual output includes a set of recipes. Each recipe may include information identifying the recipe, a cuisine or a meal associated with the recipe, a short description of the recipe, a complexity of the recipe, a set of ingredients included in the recipe, an amount or a quantity of each ingredient used to make the recipe, a set of equipment used to make the recipe, or a set of instructions for making the recipe. Each recipe also may include an amount of time required to make the recipe, a set of nutritional information associated with the recipe, a number of servings the recipe yields, or any other suitable types of information that may be associated with a recipe. In the example above, the recipe generation module 215 may receive a textual output from the LLM that includes one or more recipes for chewy chocolate chip cookies that serve five people. In this example, the textual output may include the following recipe: “Recipe for Chewy Chocolate Chip Cookies that serves 5-6. This recipe takes a total of 25 minutes to make, including 15 minutes of preparation time and 10 minutes of cooking time. To make this recipe, you will need . . . ” In embodiments in which the prompt provided to the LLM includes a request for a set of suggested modifications to the set of recipes, the textual output also may include the set of suggested modifications. In the above example, the textual output from the LLM also may include the following suggested modifications to the recipe: “Common substitutions for the butter in this recipe include avocado oil and coconut oil, while common substitutions for the white sugar in this recipe include sucralose, monk fruit sweetener, and coconut palm sugar.”

Once the recipe generation module 215 receives a textual output from the LLM, the recipe generation module 215 may extract a set of recipes from the textual output. In embodiments in which the textual output also includes a set of suggested modifications to the set of recipes, the recipe generation module 215 also may extract the set of suggested modifications from the textual output. The recipe generation module 215 may extract the set of recipes/suggested modifications by applying NLP techniques to the textual output, extracting metadata associated with the set of recipes/suggested modifications (e.g., ingredients and instructions included in each recipe/suggested modification), or by using any other suitable technique or combination of techniques. Continuing with the above example, the recipe generation module 215 may extract the recipe from the textual output, such that the recipe may include a name of the recipe (e.g., “Chewy Chocolate Chip Cookies”), a number of servings the recipe yields (e.g., “serves 5-6”), and an amount of time require to make the recipe (e.g., “25 minutes total, including 15 minutes preparation time and 10 minutes cooking time”). In this example, the recipe also may include a list of ingredients included in the recipe (e.g., “½ cup butter, ½ cup shortening, ¼ cup white sugar, . . . ”) and a set of instructions for making the recipe (e.g., “Step 1: Whisk dry ingredients together . . . ”). In the above example, the recipe generation module 215 also may extract the suggested modifications to the recipe from the textual output (e.g., “Substitute butter with: avocado oil or coconut oil” and “Substitute white sugar with: sucralose, monk fruit sweetener, or coconut palm sugar”). In some embodiments, a recipe or a suggested modification to a recipe extracted from the textual output of the LLM is collected by the data collection module 200 and stored in the data store 240.

The recipe generation module 215 also may identify one or more items associated with a recipe. The recipe generation module 215 may do so based on item data associated with various items stored in the data store 240 and the recipe (e.g., a set of ingredients included in the recipe or a set of equipment used to make the recipe). For example, suppose that an ingredient included in a recipe corresponds to ½ cup of white sugar. In this example, based on attributes of various items included among item data stored in the data store 240, the recipe generation module 215 may identify one or more items (e.g., items of various brands, prices, etc.) included in a “white sugar” item category having a size that includes at least ½ cup. If the recipe generation module 215 identifies multiple items corresponding to an ingredient included in a recipe or a type of equipment used to make the recipe, other components of the content presentation module 210 may identify one or more of those items. For example, the scoring module 212 may score items associated with a recipe for presentation to a user associated with a user client device 100 from which a request to generate the recipe was received. In this example, the ranking module 213 may rank the items based on their scores and the identification module 214 may identify one or more of the items with scores that exceed some threshold (e.g., the top n items or the p percentile of items).

In some embodiments, as part of a recipe modification process, the recipe generation module 215 generates a prompt to the LLM to modify a recipe. A recipe may be modified by changing an ingredient included in the recipe, an instruction for making the recipe, a number of servings the recipe yields, nutritional information associated with the recipe, an amount of time required to make the recipe, or in any other suitable way. For example, a recipe may be modified by substituting an ingredient with another ingredient, by making the recipe without an ingredient (e.g., meat, dairy, nuts, etc.) or by using a different quantity or amount of an ingredient. As an additional example, a recipe may be modified by making it lower in fat or by using different equipment from that specified in instructions included in the recipe (e.g., a microwave rather than an oven) or by using a different method from that specified in the instructions (e.g., baking rather than frying).

The recipe generation module 215 may generate a prompt to modify a recipe based on a request received from a user client device 100 associated with a user of the online system 140 to modify the recipe, a set of user data associated with the user, or a set of information describing the recipe. For example, suppose that the interface module 211 receives a request from a user client device 100 associated with a user of the online system 140 to modify a recipe for chewy chocolate chip cookies by substituting butter for a dairy-free alternative. In this example, based on the request and a set of user data associated with the user indicating that the user frequently orders avocado oil, the recipe generation module 215 may generate a prompt to the LLM to generate a set of modified recipes that states: “Generate some modified recipes that substitute the butter for a dairy-free alternative (preferably avocado oil) in the following recipe: Recipe for Chewy Chocolate Chip Cookies . . . ” Also, similar to a request to generate a recipe, in some embodiments, a prompt to modify a recipe also includes a request for a set of suggested modifications. In the above example, the prompt also may state: “Provide some popular modifications to each recipe.”

The recipe generation module 215 also may generate a prompt to modify a recipe based on additional types of information. Examples of such types of information include: common substitutions for one or more ingredients or types of equipment used in the recipe (e.g., ingredients/types of equipment corresponding to items included in the same item category), popular modifications made to the same or similar recipes, modifications made to similar top-rated recipes, etc. In the above example, suppose that based on item data stored in the data store 240, butter is included in an “oils/fats” item category along with other items, such as margarine, avocado oil, olive oil, coconut oil, vegetable oil, ghee, lard, canola oil, etc. In this example, suppose also that based on the recipe graph stored in the data store 240, the recipe is connected to other recipes that often include ingredients corresponding to the following items included in the “oils/fats” item category: avocado oil, vegetable oil, ghee, coconut oil, and canola oil. Continuing with this example, the prompt generated by the recipe generation module 215 to the LLM to generate the set of modified recipes may state: “Generate some modified recipes that substitute the butter for a dairy-free alternative (preferably avocado oil, vegetable oil, ghee, coconut oil, or canola oil) in the following recipe: Recipe for Chewy Chocolate Chip Cookies . . . ” Alternatively, in the above example, suppose that of the other recipes to which the recipe is connected in the recipe graph, the most popular recipes or the recipes with the highest ratings include avocado oil or coconut oil as ingredients. In this example, the prompt to the LLM generated by the recipe generation module 215 may state: “Generate some modified recipes that substitute the butter for a dairy-free alternative (preferably avocado oil or coconut oil) in the following recipe: Recipe for Chewy Chocolate Chip Cookies . . . ”

The recipe generation module 215 also may generate a prompt to modify a recipe based on a predicted availability of an item associated with the recipe (e.g., an item corresponding to an ingredient or a type of equipment used to make the recipe). In some embodiments, the recipe generation module 215 uses the availability model described above to predict an availability of an item associated with a recipe and generates a prompt to modify the recipe based on a predicted availability of the item. As described above, the availability model is a machine-learning model that is trained to predict the availability of an item at a particular retailer location. For example, suppose that the recipe generation module 215 has extracted a recipe from a textual output from the LLM, in which the recipe was generated based on a request received from a user client device 100 associated with a user and that the recipe generation module 215 has identified a set of items associated with the recipe. Continuing with this example, the recipe generation module 215 may use the availability model to predict a likelihood that each item associated with the recipe is available at a retailer location (e.g., a default retailer location associated with the user) or an estimated number of each item that is available at the retailer location. In the above example, if the predicted availability of an item is less than a threshold predicted availability, the recipe generation module 215 may generate a prompt to modify the recipe based on the predicted availability of the item (e.g., by substituting an ingredient or a type of equipment corresponding to the item with another ingredient/type of equipment, by removing the ingredient/type of equipment from the recipe, etc.).

In embodiments in which the recipe generation module 215 generates a prompt to the LLM to modify a recipe, as part of the recipe modification process, the recipe generation module 215 provides the prompt to the LLM, which generates a textual output based on the prompt. The recipe generation module 215 subsequently may receive the textual output from the LLM, in which the textual output includes a set of modified recipes. Similar to a recipe included in a textual output of the LLM, a modified recipe included in the textual output may include various types of information (e.g., information identifying the modified recipe, a cuisine or a meal associated with the modified recipe, a short description of the modified recipe, a complexity of the modified recipe, a set of ingredients included in the modified recipe, etc.). For example, suppose that the recipe generation module 215 receives a textual output from the LLM that includes one or more modified recipes for chewy chocolate chip cookies that serve five people. In this example, the textual output may include the following recipe: “Recipe for Chewy Chocolate Chip Cookies with Avocado Oil Substitution that serves 5-6. This recipe takes a total of 25 minutes to make, including 15 minutes of preparation time and 10 minutes of cooking time. To make this recipe, you will need . . . ” In embodiments in which the prompt provided to the LLM includes a request for a set of suggested modifications, the textual output also may include the set of suggested modifications. In the above example, the textual output from the LLM also may include the following suggested modifications to the recipe: “Common substitutions for the avocado oil in this recipe include coconut oil and butter, while common substitutions for the white sugar in this recipe include sucralose, monk fruit sweetener, and coconut palm sugar.”

As part of the recipe modification process, once the recipe generation module 215 receives a textual output from the LLM, the recipe generation module 215 may extract a set of modified recipes from the textual output. In embodiments in which the textual output also includes a set of suggested modifications to the set of modified recipes, the recipe generation module 215 also may extract the set of suggested modifications from the textual output. The recipe generation module 215 may extract the set of modified recipes/suggested modifications in a manner analogous to that described above (e.g., by applying NLP techniques to the textual output, extracting metadata associated with the set of modified recipes/suggested modifications, etc.). Continuing with the above example, the recipe generation module 215 may extract the modified recipe from the textual output, such that the modified recipe may include a name (e.g., “Chewy Chocolate Chip Cookies With Avocado Oil Substitution”), a number of servings the modified recipe yields (e.g., “serves 5-6”), and an amount of time require to make the modified recipe (e.g., “25 minutes total, including 15 minutes preparation time and 10 minutes cooking time”). In this example, the modified recipe also may include a list of ingredients included in the modified recipe (e.g., “½ cup avocado oil, ½ cup shortening, ¼ cup white sugar, . . . ”) and a set of instructions for making the modified recipe (e.g., “Step 1: Whisk dry ingredients together . . . ”). In the above example, the recipe generation module 215 also may extract the suggested modifications to the modified recipe from the textual output (e.g., “Substitute avocado oil with: coconut oil or butter” and “Substitute white sugar with: sucralose, monk fruit sweetener, or coconut palm sugar”). In some embodiments, a modified recipe or a suggested modification to a modified recipe extracted from the textual output of the LLM is collected by the data collection module 200 and stored in the data store 240.

The user interface generated by the interface module 211 may include a set of information describing each recipe extracted by the recipe generation module 215 and a set of options associated with each recipe. A set of information describing a recipe may correspond to the entire recipe or a portion of the recipe. For example, the user interface generated by the interface module 211 may include information describing multiple recipes for chewy chocolate chip cookies, in which each recipe is represented by an icon that includes a name of the recipe. A set of information describing a recipe also may include information the interface module 211 retrieves from the data store 240 (e.g., an image or a video associated with the recipe, a rating associated with the recipe, etc.). In the above example, if recipe data associated with the recipe stored in the data store 240 includes an image or a video associated with the recipe, the interface module 211 may generate a thumbnail image based on the image or the video and include the thumbnail image in the icon. A set of options associated with a recipe may include viewing the recipe, accepting the recipe, modifying the recipe, sharing the recipe (e.g., with other users of the online system 140 or with users of a social networking system), saving the recipe (e.g., to a user profile or account associated with the user), or any other suitable types of options that may be associated with a recipe. For example, if a set of information describing a recipe corresponds to a portion of the recipe, such as an icon including a name of the recipe, an option associated with the recipe may include viewing the recipe in its entirety. In this example, if the user interface is later updated to present the recipe in its entirety, additional options associated with the recipe may include accepting, modifying, sharing, or saving the recipe. Continuing with this example, if the recipe is accepted, additional options associated with the recipe may include adding some or all of the items associated with the recipe (e.g., items corresponding to ingredients included in the recipe or equipment used to make the recipe) to a shopping list associated with the user.

The user interface generated by the interface module 211 also may include a set of interactive elements (e.g., text fields, buttons, etc.) associated with a set of options associated with a recipe. The interface module 211 may receive a selection of an option associated with a recipe upon receiving an interaction with a corresponding interactive element from a user client device 100 associated with a user. For example, if the user interface includes a portion of a recipe, the user interface may include an icon or a “View” button associated with the recipe with which a user may interact to view the entire recipe. Alternatively, in the above example, if the user interface includes the recipe in its entirety, the user interface may include an “Accept” button associated with the recipe with which a user may interact to accept the recipe, as well as a set of suggested modifications to the recipe and a radio button associated with each suggested modification or a “Modify” button and a text field for receiving instructions for modifying the recipe. In the above example, the user interface also may include a “Save” button associated with the recipe with which a user may interact to save the recipe and a “Share” button associated with the recipe with which the user may interact to share the recipe. In this example, a user with whom the recipe is shared may perform various actions associated with the recipe (e.g., adding one or more items associated with the recipe to a shopping list, placing an order including the item(s) with the online system 140, etc.). As an additional example, if the user interface includes an accepted recipe, the user interface also may include an “Add all item(s) to shopping list” button or a checkbox associated with each item associated with the recipe and an “Add selected item(s) to shopping list” button with which a user may interact to add the corresponding item(s) to a shopping list associated with the user.

The interface module 211 also may update the user interface with various types of information. The interface module 211 may update the user interface to include information describing an entire recipe. For example, in response to receiving a request from a user to view a recipe in its entirety (e.g., in response to receiving an interaction with an icon or “View” button associated with the recipe from a user client device 100 associated with the user), the interface module 211 may update the user interface to display a corresponding recipe in its entirety. In this example, the user interface also may be updated to include interactive elements associated with various options for the recipe (e.g., an “Accept” button, a “Modify” button, a “Share” button, a “Save” button, a text field for receiving instructions for modifying the recipe, etc.). The interface module 211 also may update the user interface to include a set of information describing each modified recipe included among a set of modified recipes as part of the recipe modification process, which may be repeated until a modified recipe is accepted. Continuing with the above example, suppose that the interface module 211 receives an additional request from the user to modify the recipe (e.g., in response to receiving instructions for modifying the recipe in a text field and an interaction with a “Modify” button associated with the recipe from the user client device 100). In this example, the interface module 211 also may update the user interface to include a set of information describing each modified recipe included among a set of modified recipes and a set of options associated with each modified recipe (e.g., viewing, accepting, modifying, sharing, or saving the modified recipe). In the above example, the interface module 211 may repeat this process for each additional request received from the user to modify a recipe (if any) until a modified recipe is accepted.

In some embodiments, the interface module 211 generates or updates the user interface to include a set of information describing each recipe included among a set of recipes (e.g., each modified recipe included among a set of modified recipes) based on a predicted likelihood that a user will accept each recipe. In such embodiments, the set of recipes is identified by other components of the content presentation module 210 and the interface module 211 then sends the set of recipes for display to a user client device 100 associated with the user. For example, the scoring module 212 may use the recipe acceptance prediction model to predict a likelihood that a user will accept each recipe extracted by the recipe generation module 215 from an output of the LLM and score each recipe based on the predicted likelihood, such that the score is proportional to the predicted likelihood. In this example, the ranking module 213 may then rank the recipes based on the scores, the identification module 214 may identify a set of the recipes with scores that exceed some threshold (e.g., the top n recipes or the p percentile of recipes), and the interface module 211 then displays the identified recipes.

The interface module 211 also may update the user interface to include information describing one or more items associated with an accepted recipe and an option to add a set of the items to a shopping list associated with a user. For example, suppose that the interface module 211 receives a selection of an accepted recipe (e.g., by receiving an interaction with an “Accept” button associated with the recipe from a user client device 100 associated with a user). In this example, the interface module 211 may update the user interface to include a list of one or more items associated with the accepted recipe identified by the recipe generation module 215 and an option to add a set of the items to a shopping list associated with the user (e.g., an “Add all item(s) to shopping list” button or a checkbox associated with each item and an “Add selected item(s) to shopping list” button). As described above, if the recipe generation module 215 identifies multiple items corresponding to an ingredient included in a recipe or a type of equipment used to make a recipe, other components of the content presentation module 210 (e.g., the scoring module 212, the ranking module 213, and the identification module 214) may identify one or more of those items. The interface module 211 may then update the user interface to include information describing the identified item(s). The interface module 211 also may update the user interface to include additional options associated with an accepted recipe (e.g., to save the recipe, to share the recipe, etc.).

In some embodiments, the interface module 211 updates the user interface to include information describing one or more items associated with an accepted recipe and an option to add a set of the items to a shopping list associated with a user based on a predicted availability of each item. An availability of each item associated with an accepted recipe may be predicted by the recipe generation module 215 using the availability model, as described above. For example, suppose that the interface module 211 has received a selection of an accepted recipe from a user client device 100 associated with a user and that the recipe generation module 215 has identified one or more items associated with the recipe. In this example, suppose also that the recipe generation module 215 has used the availability model to predict a likelihood that each item is available at a retailer location (e.g., a default retailer location associated with the user) or an estimated number of items that are available at the retailer location. In the above example, the interface module 211 may update the user interface to include information describing the item(s) associated with the accepted recipe and an option to add a set of the items to a shopping list associated with the user based on the predicted availability of each item. In this example, the interface module 211 may update the user interface such that only items associated with at least a threshold predicted availability may be added to the shopping list. Alternatively, in this example, the interface module 211 may update the user interface to include the predicted availability of each item and an option to add each item to the shopping list.

The order management module 220 manages orders for items from users. The order management module 220 receives orders from user client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by users, or how often a picker agrees to service an order.

In some embodiments, the order management module 220 determines when to assign an order to a picker based on a delivery timeframe requested by the user who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online system 140. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

In embodiments in which the scoring module 212 accesses the recipe acceptance prediction model that is trained to predict a likelihood that a user will accept a recipe, the machine-learning training module 230 may train the recipe acceptance prediction model. The machine-learning training module 230 may train the recipe acceptance prediction model via supervised learning or using any other suitable technique or combination of techniques. Furthermore, the machine-learning training module 230 may train the recipe acceptance prediction model based on user data associated with users of the online system 140, recipe data associated with recipes, or any other suitable types of information. To illustrate an example of how the recipe acceptance prediction model may be trained, suppose that the machine-learning training module 230 receives a set of training examples. In this example, the set of training examples may include attributes of users, such as historical order or purchase information associated with each user, demographic and household information associated with each user, a set of preferences (e.g., favorite items or cuisines) associated with each user, a set of restrictions (e.g., food allergies or sensitivities) associated with each user, etc. In the above example, the set of training examples also may include attributes of recipes, such as a cuisine or a meal associated with each recipe, a complexity of each recipe, a set of ingredients included in each recipe, a set of nutritional information associated with each recipe, a set of instructions for making each recipe, etc. Continuing with the above example, the machine-learning training module 230 also may receive labels which represent expected outputs of the recipe acceptance prediction model. In this example, a label may indicate whether a recipe presented to a user was accepted by the user. Continuing with this example, the machine-learning training module 230 may then train the recipe acceptance prediction model based on the attributes, as well as the labels by comparing its output from input data of each training example to the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In situations in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, recipe data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

### Personalizing Recipes for Online System Users Using a Large Language Model

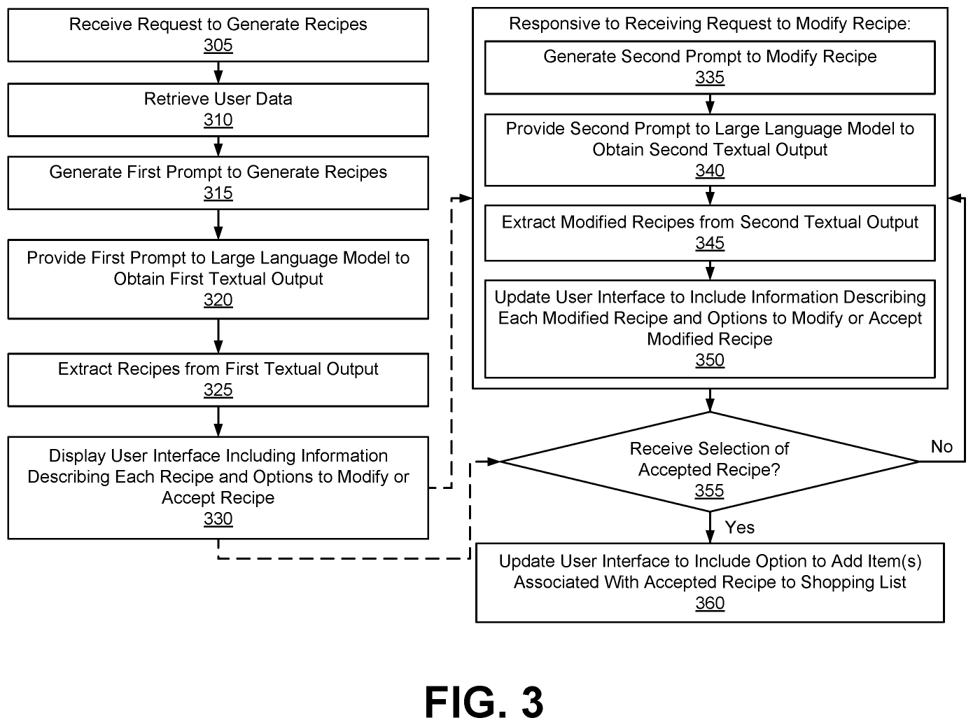

FIG. 3 is a flowchart of a method for personalizing a recipe for an online system user using a large language model, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140), such as an online concierge system. Additionally, each of these steps may be performed automatically by the online system 140 without human intervention.

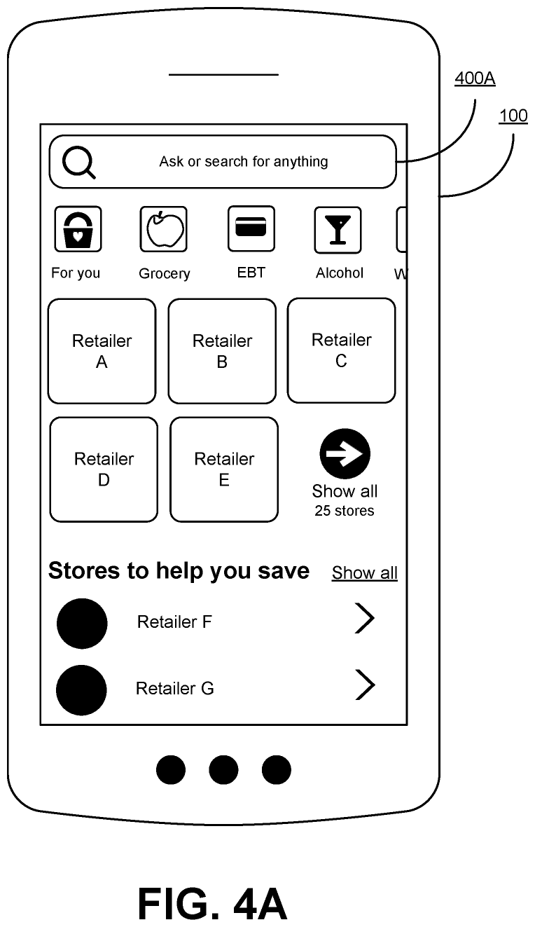

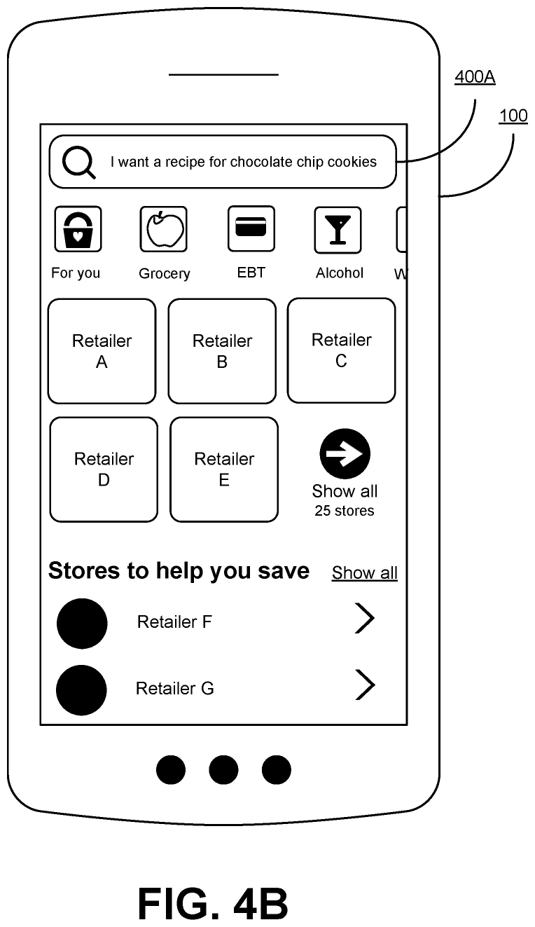

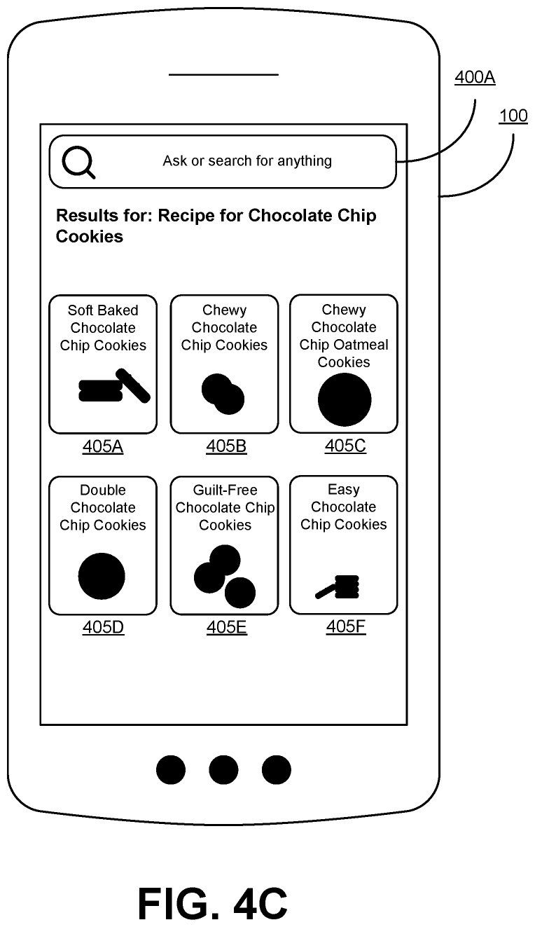

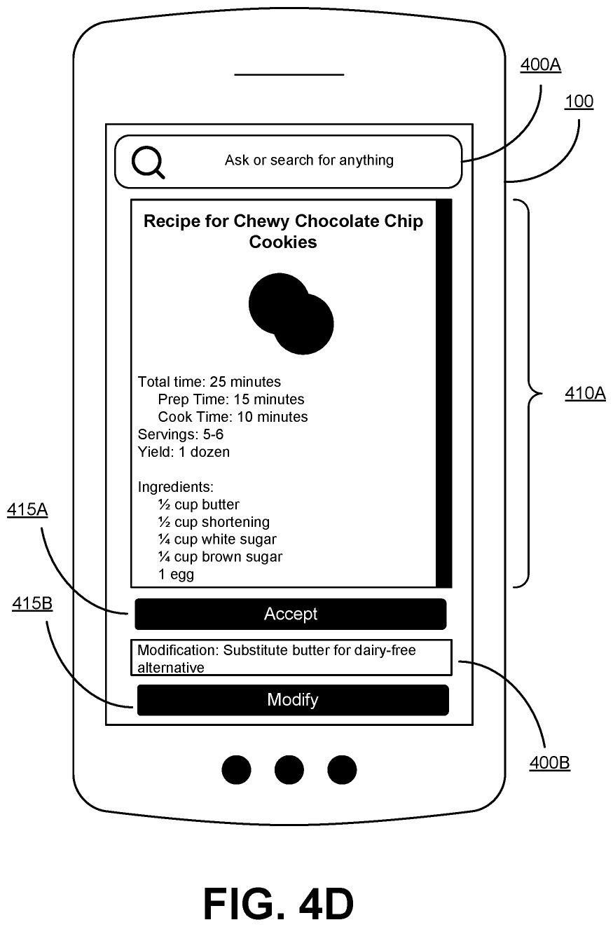

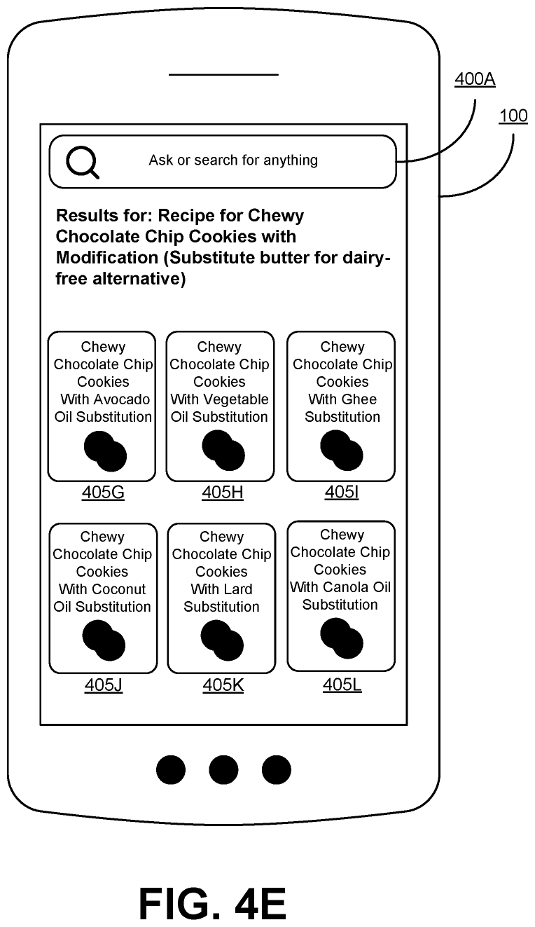

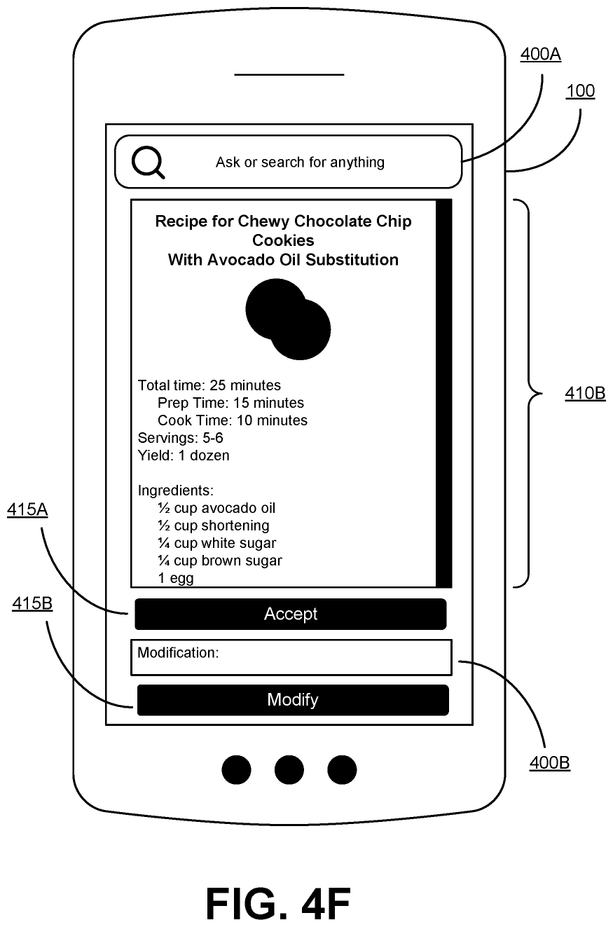

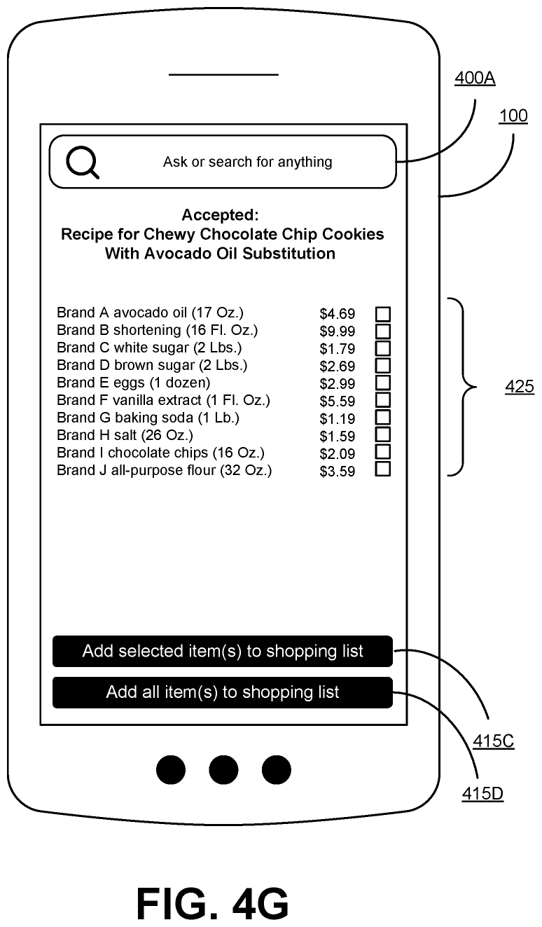

The online system 140 receives 305 (e.g., via the interface module 211) a request from a user client device 100 associated with a user of the online system 140 to generate a set of recipes. The online system 140 may receive 305 the request from the user via one or more interactive elements (e.g., a text field, one or more buttons or check boxes, etc.) included in a user interface generated (e.g., by the user interface module 211) and sent (e.g., by the user interface module 211) for display to the user client device 100 associated with the user. FIGS. 4A-4G illustrate an example of a user interface for personalizing a recipe for an online system user using a large language model, in accordance with one or more embodiments. As shown in FIG. 4A, the online system 140 may receive 305 the request from the user client device 100 via a text field 400A included in the user interface. As shown in the example of FIG. 4B, which continues the example of FIG. 4A, if the request is to generate a recipe for chocolate chip cookies, the request may be received 305 in a free-text format (e.g., “I want a recipe for chocolate chip cookies”) entered into the text field 400A.

Referring back to FIG. 3, the online system 140 then retrieves 310 (e.g., using the recipe generation module 215) a set of user data associated with the user (e.g., from the data store 240). The online system 140 may do so in response to receiving 305 the request from the user client device 100 to generate the set of recipes. For example, upon receiving 305 the request from the user client device 100 to generate the set of recipes, the online system 140 may retrieve 310 information describing a set of dietary restrictions associated with the user (e.g., a nut allergy and a lactose intolerance) and a set of preferences associated with the user (e.g., favorite items or cuisines). In the above example, the online system 140 also may retrieve 310 historical order information associated with the user describing items and quantities of items the user previously ordered and historical interaction information associated with the user describing recipes the user previously accepted. In this example, the online system 140 also may retrieve 310 information describing the user's household (e.g., five people including three children under the age of three), demographic information associated with the user (e.g., an age and a gender of the user), and an average amount a user spends on each order (e.g., between $100 and $150).

The online system 140 generates 315 (e.g., using the recipe generation module 215) a first prompt to a large language model (LLM) to generate the set of recipes. The LLM is a trained deep-learning model (e.g., GPT-4) that generates a first textual output based on the first prompt. In some embodiments, the LLM is trained by the online system 140 (e.g., using the machine-learning training module 230). The first prompt may include a set of constraints associated with the set of recipes, such as a budget associated with each recipe, one or more dietary preferences or restrictions (e.g., spicy, vegetarian, etc.) associated with each recipe, a number of servings each recipe yields, or nutritional information associated with each recipe (e.g., low sodium). The set of constraints associated with the set of recipes also may include one or more ingredients or types of equipment each recipe should include or exclude, one or more attributes of an ingredient or a type of equipment (e.g., a version/variety, a quantity, a quality, a size, etc.) each recipe should include or exclude, or any other suitable types of constraints.

The online system 140 may generate 315 the first prompt to generate the set of recipes based on the request received 305 from the user client device 100 associated with the user to generate the set of recipes, the set of user data associated with the user, or any other suitable types of information. For example, suppose that the set of user data associated with the user indicates that one of the user's favorite items is chewy chocolate chip cookies and that the user's household includes five people. In this example, based on a request received 305 from the user client device 100 associated with the user to generate a recipe for chocolate chip cookies and the set of user data, the online system 140 may generate 315 the first prompt to the LLM to generate the set of recipes that states: “Generate some recipes for chewy chocolate chip cookies that serve five people.” In some embodiments, the first prompt to generate the set of recipes also includes a request for a set of suggested modifications to the set of recipes. In the above example, the first prompt also may state: “Provide some popular modifications to each recipe.”

Once the online system 140 generates 315 the first prompt to the LLM, the online system 140 provides 320 (e.g., using the recipe generation module 215) the first prompt to the LLM, which generates the first textual output based on the first prompt. The online system 140 subsequently may receive (e.g., via the recipe generation module 215) the first textual output from the LLM, in which the first textual output includes the set of recipes. Each recipe may include information identifying the recipe, a cuisine or a meal associated with the recipe, a short description of the recipe, a complexity of the recipe, a set of ingredients included in the recipe, an amount or a quantity of each ingredient used to make the recipe, a set of equipment used to make the recipe, or a set of instructions for making the recipe. Each recipe also may include an amount of time required to make the recipe, a set of nutritional information associated with the recipe, a number of servings the recipe yields, or any other suitable types of information that may be associated with a recipe. In the example above, the online system 140 may receive the first textual output from the LLM that includes one or more recipes for chewy chocolate chip cookies that serve five people. In this example, the first textual output may include the following recipe: “Recipe for Chewy Chocolate Chip Cookies that serves 5-6. This recipe takes a total of 25 minutes to make, including 15 minutes of preparation time and 10 minutes of cooking time. To make this recipe, you will need . . . ” In embodiments in which the first prompt provided 320 to the LLM includes a request for a set of suggested modifications to the set of recipes, the first textual output also may include the set of suggested modifications. In the above example, the first textual output from the LLM also may include the following suggested modifications to the recipe: “Common substitutions for the butter in this recipe include avocado oil and coconut oil, while common substitutions for the white sugar in this recipe include sucralose, monk fruit sweetener, and coconut palm sugar.”

Once the online system 140 receives the first textual output from the LLM, the online system 140 may extract 325 (e.g., using the recipe generation module 215) the set of recipes from the first textual output. In embodiments in which the first textual output also includes a set of suggested modifications to the set of recipes, the online system 140 also may extract 325 the set of suggested modifications from the first textual output. The online system 140 may extract 325 the set of recipes/suggested modifications by applying NLP techniques to the first textual output, extracting (step 325) metadata associated with the set of recipes/suggested modifications (e.g., ingredients and instructions included in each recipe/suggested modification), or by using any other suitable technique or combination of techniques. Continuing with the above example, the online system 140 may extract 325 the recipe from the first textual output, such that the recipe may include a name of the recipe (e.g., “Chewy Chocolate Chip Cookies”), a number of servings the recipe yields (e.g., “serves 5-6”), and an amount of time require to make the recipe (e.g., “25 minutes total, including 15 minutes preparation time and 10 minutes cooking time”). In this example, the recipe also may include a list of ingredients included in the recipe (e.g., “½ cup butter, ½ cup shortening, ¼ cup white sugar, . . . ”) and a set of instructions for making the recipe (e.g., “Step 1: Whisk dry ingredients together . . . ”). In the above example, the online system 140 also may extract 325 the suggested modifications to the recipe from the first textual output (e.g., “Substitute butter with: avocado oil or coconut oil” and “Substitute white sugar with: sucralose, monk fruit sweetener, or coconut palm sugar”). In some embodiments, a recipe or a suggested modification to a recipe extracted 325 from the first textual output of the LLM is collected by the online system 140 (e.g., using the data collection module 200) and stored (e.g., in the data store 240).

The online system 140 also may identify (e.g., using the recipe generation module 215) one or more items associated with one or more of the recipes extracted 325 by the online system 140. The online system 140 may do so based on item data associated with various items (e.g., stored in the data store 240) and the recipe(s) (e.g., a set of ingredients included in each recipe or a set of equipment used to make each recipe). For example, suppose that an ingredient included in a recipe corresponds to ½ cup of white sugar. In this example, based on attributes of various items included among item data (e.g., stored in the data store 240), the online system 140 may identify one or more items (e.g., items of various brands, prices, etc.) included in a “white sugar” item category having a size that includes at least ½ cup. If the online system 140 identifies multiple items corresponding to an ingredient included in a recipe or a type of equipment used to make the recipe, other components of the online system 140 may identify one or more of those items. For example, the online system 140 may score (e.g., using the scoring module 212) items associated with a recipe for presentation to the user, rank (e.g., using the ranking module 213) the items based on their scores, and identify (e.g., using the identification module 214) one or more of the items with scores that exceed some threshold (e.g., the top n items or the p percentile of items).

The online system 140 then displays 330 (e.g., using the interface module 211) the user interface including a set of information describing each recipe extracted 325 by the online system 140 and a set of options associated with each recipe. The set of information describing each recipe may correspond to the entire recipe or a portion of the recipe. For example, as shown in FIG. 4C, which continues the example described above in conjunction with FIGS. 4A-4B, the user interface may include information describing multiple recipes for chewy chocolate chip cookies, in which each recipe is represented by an icon 405 that includes a name of the recipe. The set of information describing each recipe also may include information the online system 140 retrieves (e.g., using the interface module 211 from the data store 240), such as an image or a video associated with the recipe, a rating associated with the recipe, etc. In the above example, if recipe data associated with the recipe (e.g., stored in the data store 240) includes an image or a video associated with the recipe, the online system 140 may generate (e.g., using the interface module 211) a thumbnail image based on the image or the video and include the thumbnail image in the icon 405, as shown in FIG. 4C. The set of options associated with each recipe may include viewing the recipe, accepting the recipe, modifying the recipe, sharing the recipe (e.g., with other users of the online system 140 or with users of a social networking system), saving the recipe (e.g., to a user profile or account associated with the user), or any other suitable types of options that may be associated with a recipe. For example, if a set of information describing a recipe corresponds to a portion of the recipe, such as an icon 405 including a name of the recipe, an option associated with the recipe may include viewing the recipe in its entirety.

The user interface displayed 330 by the online system 140 also may include a set of interactive elements (e.g., text fields, buttons, etc.) associated with the set of options associated with each recipe. The online system 140 may receive (e.g., via the user interface module 211) a selection of an option associated with a recipe upon receiving an interaction with a corresponding interactive element from the user client device 100 associated with the user. For example, if the user interface includes a portion of each recipe, the user interface may include an icon 405 (as shown in FIG. 4C) or a “View” button associated with each recipe with which the user may interact to view the entire recipe. Alternatively, in the above example, if the user interface includes each recipe in its entirety, the user interface may include an “Accept” button associated with each recipe with which the user may interact to accept the recipe, as well as a set of suggested modifications to the recipe and a radio button associated with each suggested modification or a “Modify” button and a text field for receiving instructions for modifying the recipe. In the above example, the user interface also may include a “Save” button associated with the recipe with which the user may interact to save the recipe and a “Share” button associated with the recipe with which the user may interact to share the recipe. In this example, a user with whom the recipe is shared may perform various actions associated with the recipe (e.g., adding one or more items associated with the recipe to a shopping list, placing an order including the item(s) with the online system 140, etc.).

In some embodiments, the online system 140 scores (e.g., using the scoring module 212) multiple recipes extracted 325 by the online system 140 for presentation to the user and displays 330 the user interface including the set of information describing the set of recipes based on the scores. The online system 140 may score a recipe by predicting (e.g., using the scoring module 212) a likelihood that the user will accept the recipe and scoring the recipe based on the predicted likelihood (e.g., such that the score is proportional to the predicted likelihood). Once the online system 140 scores the recipes, the online system 140 may identify the set of recipes for presentation to the user. For example, the online system 140 may rank (e.g., using the ranking module 213) the recipes based on their scores, identify (e.g., using the identification module 214) the set of the recipes with scores that exceed some threshold (e.g., the top n recipes or the p percentile of recipes), and display 330 the set of information describing the set of identified recipes.

The online system 140 may predict a likelihood that the user will accept a recipe based on the set of user data associated with the user, a set of recipe data associated with the recipe, or any other suitable types of information. For example, suppose that the set of user data associated with the user retrieved 310 by the online system 140 includes information describing recipes previously accepted by the user (e.g., a cuisine or a meal associated with each recipe, a complexity of each recipe, a set of ingredients included in each recipe, a set of nutritional information associated with each recipe, etc.). In this example, the online system 140 may predict a likelihood that the user will accept a recipe based on a measure of similarity between the recipe and other recipes previously accepted by the user, such that the likelihood is proportional to the measure of similarity. In the above example, the online system 140 also may predict the likelihood based on additional types of user data associated with the user (e.g., a set of preferences or restrictions associated with the user, household or demographic information associated with the user, historical order information associated with the user, etc.). In this example, if the online system 140 identifies one or more items corresponding to each ingredient included in the recipe, the online system 140 may predict the likelihood, such that it is proportional to a number or a percentage of the ingredients corresponding to items the user previously ordered, the user's favorite or preferred items, etc. Similarly, in the above example, the likelihood may be inversely proportional to a number/percentage of ingredients corresponding to items the user does not like or prefer (e.g., based on a dietary restriction associated with the user). In the above example, the online system 140 also may predict the likelihood based on recipe data associated with other recipes having at least a threshold measure of similarity to the recipe (e.g., other recipes to which it is connected in the recipe graph), such that the likelihood may be proportional to an average measure of popularity of these recipes or an average rating for these recipes.

In some embodiments, the online system 140 predicts a likelihood that the user will accept a recipe using a recipe acceptance prediction model. A recipe acceptance prediction model is a machine-learning model trained to predict a likelihood that a user will accept a recipe. To use the recipe acceptance prediction model, the online system 140 may access (e.g., using the scoring module 212) the model (e.g., from the data store 240) and apply (e.g., using the scoring module 212) the model to a set of inputs. The set of inputs may include various types of information described above, such as the set of user data associated with the user, a set of recipe data associated with a recipe, or any other suitable types of information. For example, the set of inputs may include historical interaction information associated with the user describing recipes the user previously accepted, historical order information describing items the user previously ordered, a set of preferences or restrictions associated with the user, demographic and household information associated with the user, etc. Continuing with this example, the set of inputs further may include recipe data associated with a recipe, such as a cuisine or a meal associated with the recipe, a complexity of the recipe, a set of ingredients included in the recipe, a set of nutritional information associated with the recipe, etc. Once the online system 140 applies the recipe acceptance prediction model to a set of inputs, the online system 140 may then receive (e.g., via the scoring module 212) an output from the model corresponding to a likelihood that the user will accept a recipe. Continuing with the above example, the output received by the online system 140 may correspond to a value (e.g., a percentage) indicating a predicted likelihood that the user will accept the recipe.

In some embodiments, the recipe acceptance prediction model may be trained by the online system 140 (e.g., using the machine-learning training module 230). The online system 140 may train the recipe acceptance prediction model via supervised learning or using any other suitable technique or combination of techniques. Furthermore, the online system 140 may train the recipe acceptance prediction model based on user data for users of the online system 140, recipe data associated with recipes, or any other suitable types of information. To illustrate an example of how the recipe acceptance prediction model may be trained, suppose that the online system 140 receives a set of training examples. In this example, the set of training examples may include attributes of users, such as historical order or purchase information associated with each user, demographic and household information associated with each user, a set of preferences (e.g., favorite items or cuisines) associated with each user, a set of restrictions (e.g., food allergies or sensitivities) associated with each user, etc. In the above example, the set of training examples also may include attributes of recipes, such as a cuisine or a meal associated with each recipe, a complexity of each recipe, a set of ingredients included in each recipe, a set of nutritional information associated with each recipe, a set of instructions for making each recipe, etc. Continuing with the above example, the online system 140 also may receive labels which represent expected outputs of the recipe acceptance prediction model. In the above example, a label may indicate whether a recipe presented to a user was accepted by the user. Continuing with this example, the online system 140 may then train the recipe acceptance prediction model based on the attributes, as well as the labels by comparing its output from input data of each training example to the label for the training example.

In embodiments in which the set of information describing each recipe corresponds to a portion of the recipe, the online system 140 may update (e.g., using the interface module 211) the user interface to include information describing the entire recipe in response to receiving a selection of an option to view the recipe. For example, as shown in FIG. 4D, which continues the example described above in conjunction with FIGS. 4A-4C, in response to receiving a request from the user to view a recipe in its entirety (e.g., in response to receiving an interaction with an icon 405 or “View” button associated with the recipe from the user client device 100 associated with the user), the online system 140 may update the user interface to display a corresponding recipe in its entirety 410A. In this example, the user interface also may be updated to include interactive elements associated with various options for the recipe, such as an “Accept” button 415A, a text field 400B for receiving instructions for modifying the recipe, and a “Modify” button 415B. Although not shown in FIG. 4D, the user interface also may be updated to include additional interactive elements, such as a “Share” button 415, a “Save” button 415, etc.

Responsive to receiving an additional request from the user client device 100 associated with the user to modify a recipe, the online system 140 may perform a recipe modification process. As shown in FIG. 4D, the additional request may be received via a text field 400B in the form of instructions for modifying the recipe and when the online system 140 receives an interaction with a “Modify” button 415B associated with the recipe from the user client device 100. Referring back to FIG. 3, as part of the recipe modification process, the online system 140 generates 335 (e.g., using the recipe generation module 215) a second prompt to the LLM to modify the recipe. The recipe may be modified by changing an ingredient included in the recipe, an instruction for making the recipe, a number of servings the recipe yields, nutritional information associated with the recipe, an amount of time required to make the recipe, or in any other suitable way. For example, the recipe may be modified by substituting an ingredient with another ingredient, by making the recipe without an ingredient (e.g., meat, dairy, nuts, etc.) or by using a different quantity or amount of an ingredient. As an additional example, the recipe may be modified by making it lower in fat or by using different equipment from that specified in instructions included in the recipe (e.g., a microwave rather than an oven) or by using a different method from that specified in the instructions (e.g., baking rather than frying).

The online system 140 may generate 335 the second prompt to modify the recipe based on the additional request received from the user client device 100 associated with the user to modify the recipe, the set of user data associated with the user, or a set of information describing the recipe. For example, suppose that the online system 140 receives the request from the user client device 100 associated with the user to modify the recipe for chewy chocolate chip cookies by substituting butter for a dairy-free alternative, as shown in FIG. 4D. In this example, based on the request and the set of user data associated with the user indicating that the user frequently orders avocado oil, the online system 140 may generate 335 the second prompt to the LLM to generate the set of modified recipes that states: “Generate some modified recipes that substitute the butter for a dairy-free alternative (preferably avocado oil) in the following recipe: Recipe for Chewy Chocolate Chip Cookies . . . ” Also, similar to the first prompt to generate the recipe, in some embodiments, the second prompt to modify the recipe also includes a request for a set of suggested modifications. In the above example, the second prompt also may state: “Provide some popular modifications to each recipe.”

The online system 140 also may generate 335 the second prompt to modify the recipe based on additional types of information. Examples of such types of information include: common substitutions for one or more ingredients or types of equipment used in the recipe (e.g., ingredients/types of equipment corresponding to items included in the same item category), popular modifications made to the same or similar recipes, modifications made to similar top-rated recipes, etc. In the above example, suppose that based on item data (e.g., stored in the data store 240), butter is included in an “oils/fats” item category along with other items, such as margarine, avocado oil, olive oil, coconut oil, vegetable oil, ghee, lard, canola oil, etc. In this example, suppose also that based on the recipe graph (e.g., stored in the data store 240), the recipe is connected to other recipes that often include ingredients corresponding to the following items included in the “oils/fats” item category: avocado oil, vegetable oil, ghee, coconut oil, and canola oil. Continuing with this example, the second prompt generated 335 by the online system 140 to the LLM to generate the set of modified recipes may state: “Generate some modified recipes that substitute the butter for a dairy-free alternative (preferably avocado oil, vegetable oil, ghee, coconut oil, or canola oil) in the following recipe: Recipe for Chewy Chocolate Chip Cookies . . . ” Alternatively, in the above example, suppose that of the other recipes to which the recipe is connected in the recipe graph, the most popular recipes or the recipes with the highest ratings include avocado oil or coconut oil as ingredients. In this example, the second prompt to the LLM generated 335 by the online system 140 may state: “Generate some modified recipes that substitute the butter for a dairy-free alternative (preferably avocado oil or coconut oil) in the following recipe: Recipe for Chewy Chocolate Chip Cookies . . . ”

The online system 140 also may generate 335 the second prompt to modify the recipe based on a predicted availability of an item associated with the recipe. In some embodiments, the online system 140 predicts (e.g., using the recipe generation module 215) an availability of an item associated with the recipe (e.g., an item corresponding to an ingredient or a type of equipment used to make the recipe) using the availability model described above and generates 335 the second prompt to modify the recipe based on the predicted availability of the item. As described above, the availability model is a machine-learning model that is trained to predict the availability of an item at a particular retailer location. For example, the online system 140 may use the availability model to predict a likelihood that each item associated with the recipe is available at a retailer location (e.g., a default retailer location associated with the user) or an estimated number of each item that is available at the retailer location. In the above example, if the predicted availability of an item is less than a threshold predicted availability, the online system 140 may generate 335 the second prompt to modify the recipe based on the predicted availability of the item (e.g., by substituting an ingredient or a type of equipment corresponding to the item with another ingredient/type of equipment, by removing the ingredient/type of equipment from the recipe, etc.).

Referring back to FIG. 3, as part of the recipe modification process, the online system 140 then provides 340 (e.g., using the recipe generation module 215) the second prompt to modify the recipe to the LLM, which generates a second textual output based on the second prompt. The online system 140 subsequently may receive (e.g., using the recipe generation module 215) the second textual output from the LLM, in which the textual output includes a set of modified recipes. Similar to each recipe included in the first textual output of the LLM, each modified recipe included in the second textual output may include various types of information (e.g., information identifying the modified recipe, a cuisine or a meal associated with the modified recipe, a short description of the modified recipe, a complexity of the modified recipe, a set of ingredients included in the modified recipe, etc.). For example, suppose that the online system 140 receives the second textual output from the LLM that includes a set of modified recipes for chewy chocolate chip cookies that serve five people. In this example, the second textual output may include the following recipe: “Recipe for Chewy Chocolate Chip Cookies with Avocado Oil Substitution that serves 5-6. This recipe takes a total of 25 minutes to make, including 15 minutes of preparation time and 10 minutes of cooking time. To make this recipe, you will need . . . ” In embodiments in which the second prompt provided 340 to the LLM includes a request for a set of suggested modifications, the second textual output also may include the set of suggested modifications. In the above example, the second textual output from the LLM also may include the following suggested modifications to the recipe: “Common substitutions for the avocado oil in this recipe include coconut oil and butter, while common substitutions for the white sugar in this recipe include sucralose, monk fruit sweetener, and coconut palm sugar.”

As part of the recipe modification process, once the online system 140 receives the second textual output from the LLM, the online system 140 may extract 345 (e.g., using the recipe generation module 215) the set of modified recipes from the second textual output. In embodiments in which the second textual output also includes a set of suggested modifications to the set of modified recipes, the online system 140 also may extract 345 the set of suggested modifications from the second textual output. The online system 140 may extract 345 the set of modified recipes/suggested modifications in a manner analogous to that described above (e.g., by applying NLP techniques to the second textual output, extracting (step 345) metadata associated with the set of modified recipes/suggested modifications, etc.). Continuing with the above example, the online system 140 may extract 345 the modified recipe from the second textual output, such that the modified recipe may include a name (e.g., “Chewy Chocolate Chip Cookies With Avocado Oil Substitution”), a number of servings the modified recipe yields (e.g., “serves 5-6”), and an amount of time require to make the modified recipe (e.g., “25 minutes total, including 15 minutes preparation time and 10 minutes cooking time”). In this example, the modified recipe also may include a list of ingredients included in the modified recipe (e.g., “½ cup avocado oil, ½ cup shortening, ¼ cup white sugar, . . . ”) and a set of instructions for making the modified recipe (e.g., “Step 1: Whisk dry ingredients together . . . ”). In the above example, the online system 140 also may extract 345 the suggested modifications to the modified recipe from the second textual output (e.g., “Substitute avocado oil with: coconut oil or butter” and “Substitute white sugar with: sucralose, monk fruit sweetener, or coconut palm sugar”). In some embodiments, a modified recipe or a suggested modification to a modified recipe extracted 345 from the second textual output of the LLM is collected by the online system 140 (e.g., using the data collection module 200) and stored (e.g., in the data store 240).

As part of the recipe modification process, the online system 140 also may update 350 (e.g., using the interface module 211) the user interface to include a set of information describing each modified recipe included among the set of modified recipes and a set of options associated with each modified recipe (e.g., viewing, accepting, modifying, sharing, or saving the modified recipe). For example, as shown in FIG. 4E, which continues the example described above in conjunction with FIGS. 4A-4D, the online system 140 may update 350 the user interface to include information describing multiple modified recipes for chewy chocolate chip cookies, in which each modified recipe is represented by an icon 405 that includes a name of the modified recipe. Referring again to FIG. 3, the online system 140 may repeat the recipe modification process for each additional request received from the user to modify a recipe (if any) until a modified recipe is accepted (e.g., by proceeding back to the generating 335 a second prompt to modify a recipe step, etc.).

The online system 140 may update 350 the user interface to include the set of information describing each modified recipe based on a predicted likelihood that the user will accept each modified recipe. In some embodiments, the online system 140 identifies the set of modified recipes and then displays the set of modified recipes. For example, the online system 140 may predict (e.g., using the scoring module 212) a likelihood that the user will accept each modified recipe extracted 345 by the online system 140 (e.g., using the recipe acceptance prediction model) and score (e.g., using the scoring module 212) each modified recipe based on the predicted likelihood, such that the score is proportional to the predicted likelihood. In this example, the online system 140 may then rank (e.g., using the ranking module 213) the modified recipes based on the scores, identify (e.g., using the identification module 214) the set of modified recipes with scores that exceed some threshold (e.g., the top n modified recipes or the p percentile of modified recipes), and update 350 the user interface to include the set of information describing each modified recipe that is identified.

Responsive to receiving 355 (e.g., via the interface module 211) a selection of an accepted recipe from the user client device 100 associated with the user, the online system 140 may update 360 (e.g., using the interface module 211) the user interface to include information describing one or more items associated with the accepted recipe and an option to add a set of the items to a shopping list associated with the user. The accepted recipe may be a recipe extracted 325 from the first textual output included in the user interface displayed 330 to the user or a modified recipe extracted 345 from the second textual output included in the updated user interface. As shown in FIG. 4F, which continues the example described above in conjunction with FIGS. 4A-4E, suppose that the online system 140 receives 355 a selection of an accepted recipe by receiving 355 an interaction with an “Accept” button 415A associated with the modified recipe displayed in its entirety 410B from the user client device 100 associated with the user. As shown in FIG. 4G, in this example, the online system 140 may update 360 the user interface to include a list 425 of one or more items associated with the accepted recipe and an option to add a set of the items to a shopping list associated with the user (e.g., a checkbox associated with each item and an “Add selected item(s) to shopping list” button 415C or an “Add all item(s) to shopping list” button 415D). As described above, if the online system 140 identifies multiple items corresponding to an ingredient included in the accepted recipe or a type of equipment used to make the accepted recipe, the online system 140 may identify one or more of those items (e.g., using the scoring module 212, the ranking module 213, and the identification module 214). The online system 140 may then update 360 the user interface to include information describing the identified item(s). Although not shown in FIG. 4G, the online system 140 also may update 360 the user interface to include additional options associated with the accepted recipe (e.g., to save the recipe, to share the recipe, etc.).

In some embodiments, the online system 140 updates 360 the user interface to include the information describing the item(s) associated with the accepted recipe and the option to add a set of the items to the shopping list associated with the user based on a predicted availability of each item. An availability of each item associated with the accepted recipe may be predicted (e.g., by the recipe generation module 215) using the availability model, as described above. For example, suppose that the online system 140 has used the availability model to predict a likelihood that each item associated with the accepted recipe is available at a retailer location (e.g., a default retailer location associated with the user) or an estimated number of items that are available at the retailer location. In the above example, the online system 140 may update 360 the user interface to include information describing the item(s) associated with the accepted recipe and the option to add a set of the items to a shopping list associated with the user based on the predicted availability of each item. In this example, the online system 140 may update 360 the user interface such that only items associated with at least a threshold predicted availability may be added to the shopping list. Alternatively, in this example, the online system 140 may update 360 the user interface to include the predicted availability of each item and the option to add each item to the shopping list.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online system, a request from a client device associated with a user of the online system to generate a set of recipes;
retrieving a set of user data associated with the user;
generating a first prompt to generate the set of recipes based at least in part on the request and the set of user data;
providing the first prompt to a large language model to obtain a first textual output, the first textual output including the set of recipes;
extracting the set of recipes from the first textual output;
displaying a user interface comprising a set of information describing each recipe of the set of recipes and a set of options to modify a recipe and to accept the recipe;
responsive to receiving an additional request from the client device to modify the recipe, performing a recipe modification process comprising:
generating a second prompt to modify the recipe based at least in part on the additional request, the set of information describing the recipe, and the set of user data associated with the user,
providing the second prompt to the large language model to obtain a second textual output, the second textual output including a set of modified recipes,
extracting the set of modified recipes from the second textual output, and
updating the user interface to include the set of information describing each modified recipe of the set of modified recipes and the set of options to modify a modified recipe and to accept the modified recipe;
repeating the recipe modification process for each additional request received from the client device until a modified recipe is accepted;
responsive to receiving a selection of an accepted recipe from the client device, predicting an availability of each item of one or more items associated with the accepted recipe at a retailer location; and
updating the user interface to include an additional option to add a set of items of the one or more items associated with the accepted recipe to a shopping list associated with the user based at least in part on the predicted availability of each item, wherein updating the user interface causes the client device to display the updated user interface.

2. The method of claim 1, wherein retrieving a set of user data associated with the user comprises retrieving one or more of: historical order information associated with the user or a set of preferences associated with the user.

3. The method of claim 1, wherein updating the user interface to include the set of information describing each modified recipe comprises updating the user interface to include a modification to one or more of: an ingredient included in the recipe, an instruction for making the recipe, a number of servings the recipe yields, nutritional information associated with the recipe, or an amount of time required to make the recipe.

4. The method of claim 1, wherein displaying a user interface comprising a set of information describing each recipe comprises displaying a user interface comprising information identifying each recipe of the set of recipes.

5. The method of claim 4, wherein displaying the user interface comprising the set of information describing each recipe of the set of recipes and the set of options to modify the recipe and to accept the recipe comprises:
responsive to receiving, from the client device, a request to view the recipe, updating the user interface to include an additional set of information describing the recipe and the set of options to modify the recipe and to accept the recipe.

6. The method of claim 5, wherein updating the user interface to include an additional set of information comprises updating the user interface to include one or more of: a set of ingredients included in the recipe, a set of instructions for making the recipe, an amount of time required to make the recipe, a set of nutritional information associated with the recipe, or a number of servings the recipe yields.

7. The method of claim 1, wherein generating the second prompt to modify the recipe based at least in part on the additional request comprises:
extracting a set of metadata from the set of information describing the recipe; and
generating the second prompt based at least in part on the set of metadata.

8. The method of claim 1, wherein generating the second prompt is further based at least in part on a measure of popularity of a modification to one or more of: the recipe and one or more recipes having at least a threshold measure of similarity to the recipe.

9. The method of claim 1, further comprising:
accessing a machine-learning model trained to predict a likelihood that the user will accept a recipe, wherein the machine-learning model is trained by:
receiving recipe data associated with a first plurality of recipes,
receiving user data associated with a plurality of users,
receiving, for each recipe of the first plurality of recipes, a label indicating whether a corresponding recipe was accepted by a viewing user presented with the corresponding recipe, and
training the machine-learning model based at least in part on the recipe data, the user data, and the label for each recipe of the first plurality of recipes;
for each recipe of a second plurality of recipes extracted from the first textual output, applying the machine-learning model to predict a likelihood that the user will accept a corresponding recipe based at least in part on the set of user data associated with the user and a set of recipe data associated with the corresponding recipe;
ranking the second plurality of recipes extracted from the first textual output based at least in part on the likelihood predicted for each recipe; and
selecting the set of recipes extracted from the first textual output based at least in part on the ranking.

10. The method of claim 1, further comprising:
extracting one or more of the set of options from the first textual output.

11. A computer program product comprising a non-transitory computer-readable storage medium having instructions encoded thereon that, when executed by a processor, cause the processor to perform steps comprising:
receiving, at an online system, a request from a client device associated with a user of the online system to generate a set of recipes;
retrieving a set of user data associated with the user;
generating a first prompt to generate the set of recipes based at least in part on the request and the set of user data;
providing the first prompt to a large language model to obtain a first textual output, the first textual output including the set of recipes;
extracting the set of recipes from the first textual output;
displaying a user interface comprising a set of information describing each recipe of the set of recipes and a set of options to modify a recipe and to accept the recipe;
responsive to receiving an additional request from the client device to modify the recipe, performing a recipe modification process comprising:
generating a second prompt to modify the recipe based at least in part on the additional request, the set of information describing the recipe, and the set of user data associated with the user,
providing the second prompt to the large language model to obtain a second textual output, the second textual output including a set of modified recipes,
extracting the set of modified recipes from the second textual output, and
updating the user interface to include the set of information describing each modified recipe of the set of modified recipes and the set of options to modify a modified recipe and to accept the modified recipe;
repeating the recipe modification process for each additional request received from the client device until a modified recipe is accepted;
responsive to receiving a selection of an accepted recipe from the client device, predicting an availability of each item of one or more items associated with the accepted recipe at a retailer location; and
updating the user interface to include an additional option to add a set of items of the one or more items associated with the accepted recipe to a shopping list associated with the user based at least in part on the predicted availability of each item, wherein updating the user interface causes the client device to display the updated user interface.

12. The computer program product of claim 11, wherein retrieving a set of user data associated with the user comprises retrieving one or more of: historical order information associated with the user or a set of preferences associated with the user.

13. The computer program product of claim 11, wherein updating the user interface to include the set of information describing each modified recipe comprises updating the user interface to include a modification to one or more of: an ingredient included in the recipe, an instruction for making the recipe, a number of servings the recipe yields, nutritional information associated with the recipe, or an amount of time required to make the recipe.

14. The computer program product of claim 11, wherein displaying a user interface comprising a set of information describing each recipe comprises displaying a user interface comprising information identifying each recipe of the set of recipes.

15. The computer program product of claim 14, wherein displaying the user interface comprising the set of information describing each recipe of the set of recipes and the set of options to modify the recipe and to accept the recipe comprises:
responsive to receiving, from the client device, a request to view the recipe, updating the user interface to include an additional set of information describing the recipe and the set of options to modify the recipe and to accept the recipe.

16. The computer program product of claim 15, wherein updating the user interface to include an additional set of information comprises updating the user interface to include one or more of: a set of ingredients included in the recipe, a set of instructions for making the recipe, an amount of time required to make the recipe, a set of nutritional information associated with the recipe, or a number of servings the recipe yields.

17. The computer program product of claim 11, wherein generating the second prompt to modify the recipe based at least in part on the additional request comprises:
extracting a set of metadata from the set of information describing the recipe; and
generating the second prompt based at least in part on the set of metadata.

18. The computer program product of claim 11, wherein generating the second prompt is further based at least in part on a measure of popularity of a modification to one or more of: the recipe and one or more recipes having at least a threshold measure of similarity to the recipe.

19. The computer program product of claim 11, wherein the computer-readable storage medium further has instructions encoded thereon that, when executed by the processor, cause the processor to perform steps comprising:
accessing a machine-learning model trained to predict a likelihood that the user will accept a recipe, wherein the machine-learning model is trained by:
receiving recipe data associated with a first plurality of recipes,
receiving user data associated with a plurality of users,
receiving, for each recipe of the first plurality of recipes, a label indicating whether a corresponding recipe was accepted by a viewing user presented with the corresponding recipe, and
training the machine-learning model based at least in part on the recipe data, the user data, and the label for each recipe of the first plurality of recipes;
for each recipe of a second plurality of recipes extracted from the first textual output, applying the machine-learning model to predict a likelihood that the user will accept a corresponding recipe based at least in part on the set of user data associated with the user and a set of recipe data associated with the corresponding recipe;
ranking the second plurality of recipes extracted from the first textual output based at least in part on the likelihood predicted for each recipe; and
selecting the set of recipes extracted from the first textual output based at least in part on the ranking.

20. A computer system comprising:
a processor; and
a non-transitory computer-readable storage medium storing instructions that, when executed by the processor, perform actions comprising:
receiving, at an online system, a request from a client device associated with a user of the online system to generate a set of recipes;
retrieving a set of user data associated with the user;
generating a first prompt to generate the set of recipes based at least in part on the request and the set of user data;
providing the first prompt to a large language model to obtain a first textual output, the first textual output including the set of recipes;
extracting the set of recipes from the first textual output;
displaying a user interface comprising a set of information describing each recipe of the set of recipes and a set of options to modify a recipe and to accept the recipe;
responsive to receiving an additional request from the client device to modify the recipe, performing a recipe modification process comprising:
generating a second prompt to modify the recipe based at least in part on the additional request, the set of information describing the recipe, and the set of user data associated with the user,
providing the second prompt to the large language model to obtain a second textual output, the second textual output including a set of modified recipes,
extracting the set of modified recipes from the second textual output, and
updating the user interface to include the set of information describing each modified recipe of the set of modified recipes and the set of options to modify a modified recipe and to accept the modified recipe;
repeating the recipe modification process for each additional request received from the client device until a modified recipe is accepted;
responsive to receiving a selection of an accepted recipe from the client device, predicting an availability of each item of one or more items associated with the accepted recipe at a retailer location; and
updating the user interface to include an additional option to add a set of items of the one or more items associated with the accepted recipe to a shopping list associated with the user based at least in part on the predicted availability of each item, wherein updating the user interface causes the client device to display the updated user interface.
